(19) United States
(12) Patent Application Publication
(10) Pub. No.: US 2009/0074527 A1
(43) Pub. Date: Mar. 19, 2009

(54) Drilling Tool

(76) Inventors: Toshio Kamizaki, Mie (JP); Tamotsu Fukushima, Mie (JP); Isao Tabei, Mie (JP)

Correspondence Address: THE NATH LAW GROUP, 112 South West Street, Alexandria, VA, 22314, US

(21) Appl. No.: 11/887,738

(22) PCT Filed: Apr. 4, 2006
(86) PCT No.: PCT/JP2006/307107

§ 371 Date: Mar. 3, 2008

(30) Foreign Application Priority Data
Apr. 4, 2005 (JP) 2005-107772

(51) Int. Cl. B23B 51/00; B23B 51/02

(52) U.S. Cl. 408/230; 408/223

(57) ABSTRACT

A cutting blade 5 is formed by firmly fixing a tip 4 comprising a superabrasive compact to the top end of a shank 2. Nick grooves are formed on the cutting blade as a lateral separation means for separating swarf in the lateral direction and rounding treatment is applied to the cutting edge 6 of the cutting blade in order to configure a longitudinal separation means for separating the swarf in the longitudinal direction. The swarf is separated at the part of the cutting blade in both the lateral and longitudinal directions and fractionized into very fine pieces. By doing so, it is possible to provide a drilling tool which allows swarf to be surely separated in the lateral and longitudinal directions and fractionized even when a hole is created with a large machining thickness in the radial direction.

### TECHNICAL FIELD

The present invention relates to: a drilling tool such as a reamer, a drill or the like, which has cutting blades comprising superabrasive compacts made of superabrasives such as diamond, CBN or the like; more specifically, a drilling tool, which allows swarf generated during drilling can be fractionized to a larger extent than ever before, thereby being superior in dischargeability, and hardly causing deposition to the cutting blades of the tool.

### BACKGROUND ART

When a hole requiring a good dimensional accuracy is bored, conventional practice has been that: first a hole has been made with a drill; and successively the slightly remaining machining allowance has been removed with a reamer and thereby an intended accuracy has been secured. Meanwhile, JP, A, 11-129109 describes a tool which: uses a reamer tip made of HSS (high-speed tool steel); has a drilling blade and a reaming blade formed on the outer circumference on the rear side of the drilling blade in the axial direction; and is used for the simultaneous processing of drilling and reaming as a single tool. Then it describes the case where, as shown in FIGS. 3 and 4, nicks are formed on the drilling blade to cut swarf in the lateral direction and furthermore chip breakers are formed at positions on the rear side of the drilling blade in the axial direction to cut the swarf in the longth.

Patent Document 1: JP, A, 11-129109

### DISCLOSURE OF THE INVENTION

### Problem to be solved by the Invention

However, when a drilling blade and a reaming blade are separately formed at different positions and processing is carried out simultaneously with both the blades as stated above, the tool inevitably receives a heavier load. Then, since both the blades are formed separately from each other at a distance in the axial direction, a long work stroke is required. Moreover, since nicks and breakers are formed separately from each other at a distance in the axial direction, swarf cut into a narrow width by the nicks becomes slender and hardly breaks even when the swarf hits the breakers, and therefore it is feared that separation in the longitudinal direction may not be assured.

Meanwhile, in the case of a drilling tool having a cutting blade comprising a superabrasive compact made of superabrasives such as diamond, CBN, or the like, processing of high accuracy can be realized even when machining thickness at one time is large, for example 3 mm or more. Further, the drilling tool hardly generates composed cutting blades and is also suitable for the processing of aluminum alloy or the like. However, an edge of a cutting blade comprising a superabrasive compact is generally sharpened and thereby streamlined swarf, namely lengthy swarf, is produced. Further, as a machining thickness increases, the width of the generated swarf also increases. Lengthy swarf is entangled in the tool and causes the problem of difficulty in discharge, and wide swarf also has difficulty in discharge and may get into and damage the material being machined in some cases. It is possible to separate swarf in the lateral direction by forming nicks on a cutting blade. However, even though breakers are formed as explained in reference to JP, A, 11-129109, the swarf is hardly separated in the longitudinal direction, it is feared that lengthy swarf may be continuously produced, and the problems of difficulty in discharge of the swarf and damages to the material being machined still remain.

The present invention has been established in view of the above conventional problems and an object of the present invention is to provide a drilling tool using a superabrasive compact, which allows swarf to be surely separated in the lateral and longitudinal directions and fractionized even when a hole is bored with a large machining thickness in the radial direction.

### Means for solving the Problem

In order to solve the above problems, in the present invention, the cutting blades of a drilling tool produced by firmly fixing a tip comprising a superabrasive compact at the top end of a spindle-shaped shank and thus forming cutting blades at the tip are provided with: a longitudinal separation means for separating swarf generated at the cutting edges of the cutting blades in the direction of the length of the swarf; and a lateral separation means for separating the swarf in the direction of the width thereof. By so doing, the swarf is separated in both the longitudinal and lateral directions at the parts of the cutting blades and fractionized to a larger extent than ever before.

In an embodiment, the longitudinal separation means is formed by dulling treatment to dull the machinability of the cutting edges and the lateral separation means includes nick grooves.

Further, in another embodiment, the length of the cutting edges of the cutting blades is three millimeters or longer in the radial direction of the shank.

Furthermore, in another embodiment: at least two or more cutting blades are formed separately from each other at a distance in the axial direction of the shank at positions different from each other in the radial direction of the shank; and at least one of the cutting edges is provided with the longitudinal separation means and the lateral separation means.

### EFFECT OF THE INVENTION

In the present invention, since a cutting blade comprising a superabrasive compact is provided with both the lateral separation means for separating swarf in the lateral direction and the longitudinal separation means for separating the swarf in the longitudinal direction, the swarf is separated without fail in both the lateral and longitudinal directions at the part of the cutting blade and hence fractionized to a considerably larger extent than ever before. Consequently, the present invention is superior in dischargeability of the swarf and can prevent the material being machined from being damaged. Moreover, since the cutting blade comprises a superabrasive compact, deposition of swarf to the cutting blade does not occur even when the cutting blade is provided with the longitudinal separation means and machinability enough to obtain sufficient processing accuracy can be maintained. With regard to the longitudinal separation means in particular, whereas a chip breaker is configured so as to fold and separate the swarf once generated in a lengthy state and hence the reliability of the separation is inferior, the cutting blade is provided with the longitudinal separation means and hence the separation can be secured without fail in the present invention.

### BRIEF DESCRIPTION OF THE DRAWINGS

FIG. 1 comprises views showing a drill as a drilling tool according to the first embodiment of the present invention.

FIG. 2 shows the details of a cutting blade, and FIG. 2(a) is an enlarged view showing the part A of FIG. 1(a) and FIG. 2(b) is a view taken in the direction of an arrow in FIG. 2(a).

FIG. 3 is a view showing the locations of nick grooves on the other cutting blade.

FIG. 4 is a view showing chamfer treatment as dulling treatment adopted in the second embodiment.

FIG. 5 is a view showing the lateral separation means adopted in the third embodiment.

FIG. 6 shows a reamer according to the fourth embodiment and comprises a partial front view and an enlarged view showing the part H of the partial front view.

FIG. 7 is a photograph of swarf generated in the example 1.

FIG. 8 is a photograph of swarf generated in the comparative example 1.

FIG. 9 is a photograph of swarf generated in the comparative example 2.

### DESCRIPTION OF THE REFERENCE NUMERALS

1 Drill (drilling tool)
2 Shank
3 Swarf discharging groove
4 Tip
5 Cutting blade
6 Cutting edge
7 Nick groove

### BEST MODES FOR CARRYING OUT THE INVENTION

The concrete embodiments according to the present invention will be explained hereunder in reference to the drawings. However, the scope of the present invention is not limited to the embodiments explained below.

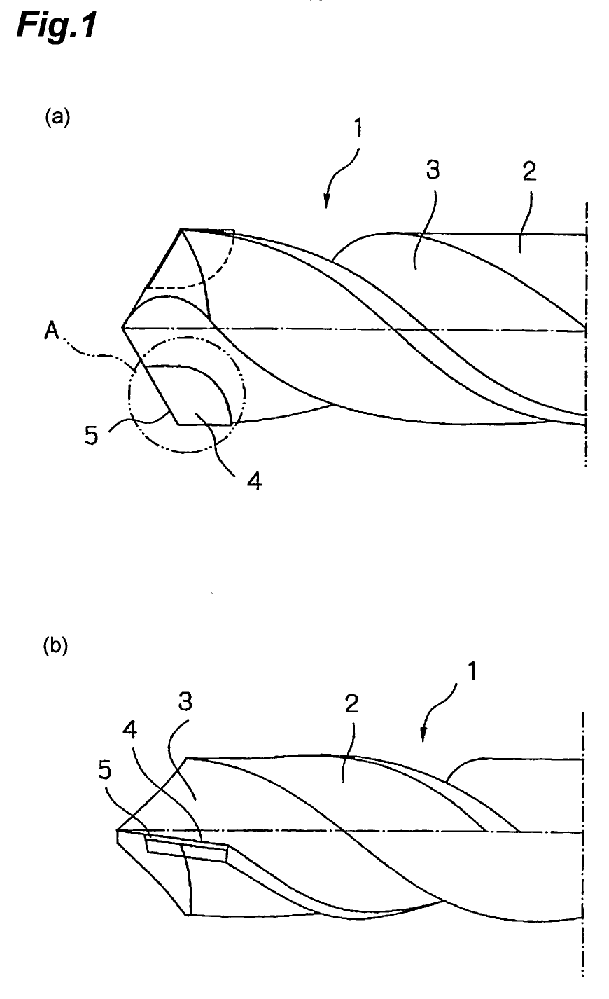

FIG. 1 comprises views showing a drilling tool according to the first embodiment of the present invention, more specifically, a drill 1, wherein FIG. 1(a) is a partial front view and FIG. 1(b) is a bottom view. The spindle-shaped shank 2 of the drill 1 is made of a steel material, a carbide steel, or the like and has swarf discharging grooves 3. Tips 4, each of which comprises a superabrasive compact such as a diamond compact, a CBN compact or the like, are firmly fixed to one end, namely a top end, of the shank 2 by means of brazing or the like and thus cutting blades 5 are configured. Here, in the present embodiment, two tips are provided as the tips 4 at a distant angle of 180 degrees from each other in the direction of the circumference of the shank 2. The structure above described is publicly known, the shape of the tips 4 is not particularly limited to that shown in the figures, and the minimum requirement is that cutting blades 5 extending from the center to the outer circumference of the shank 2 in the radial direction are formed. Here, although the explanations have been made on the basis of the case where tips 4 comprising superabrasive compacts are firmly fixed to the shank 2, the tips 4 including the shank 2 may be formed by shaving a solid superabrasive compact and the present patent application also stipulates the case as a case where the tips 4 are formed.

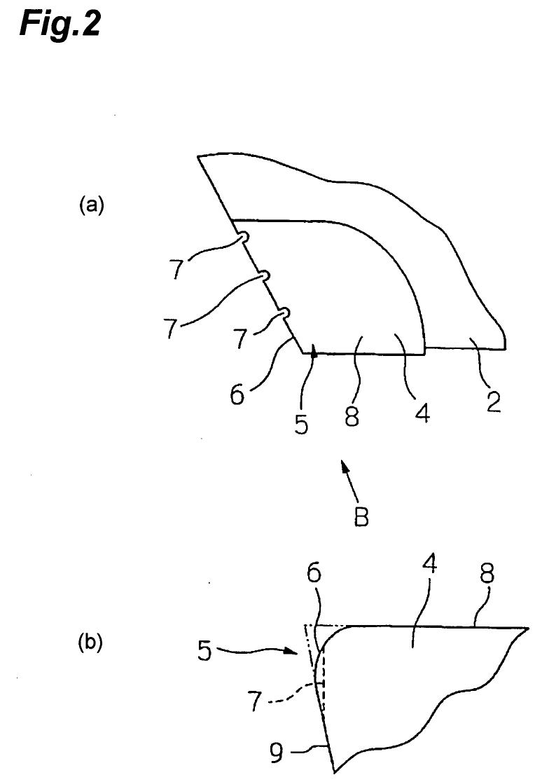

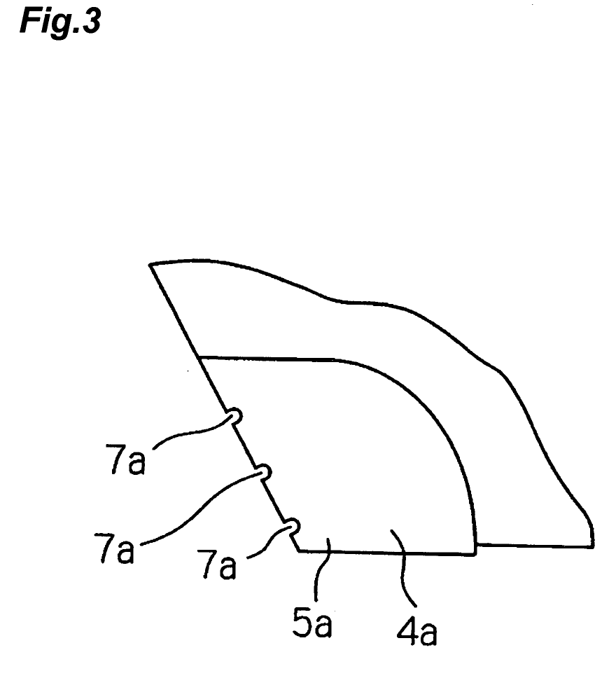

FIG. 2 comprises views sowing the details of a cutting blade 5, and FIG. 2(a) is an enlarged view showing the part A of FIG. 1(a) and FIG. 2(b) is a view taken in the direction of the arrow B in FIG. 2(a). The reference numeral 8 in the figures represents a cutting face and the reference numeral 9 represents a discharging face. As shown in the figures, in the present embodiment, three nick grooves 7 are formed at the part of the cutting edge 6 of the cutting blade 5. The nick grooves 7 themselves are publicly known and hence detailed explanations on them are omitted. The depth and the width of each of the nick grooves 7 can be appropriately set so as to be suitable for the specification of the drilling tool 1. By forming the nick grooves 7, swarf generated with the cutting blade 5 is separated in the lateral direction at the places where the nick grooves 7 are formed. Here, in the present embodiment, two tips 4 are mounted as described above, and the positions of the nick grooves 7a formed on the cutting blade 5a of a tip 4a are differentiated from the positions of the nick grooves 7 formed on the cutting blade 5 of the other tip 4 in the longitudinal directions of the cutting blades 5 and 5a as shown in FIG. 3.

As shown in FIG. 2(b), rounding treatment to somewhat round a cutting edge 6 is applied to the cutting blade 5. That is, when a cutting blade comprises a superabrasive compact, usually the cutting edge is formed into a sharp edge as illustrated with a two-dot chain line in FIG. 3 but, in the present embodiment, the cutting edge 6 is rounded as illustrated in the figure. The rounding treatment is implemented by honing in the present embodiment. Thereby, swarf generated at the cutting edge 6 is folded immediately after being generated, namely in a very short period of time, due to the function of the rounded part. That is, the swarf is separated in the longitudinal direction and cannot become lengthy swarf. Here, the treatment to dull the sharpness of swarf 5 as described above is defined as dulling treatment in the present patent application. As a means for separating swarf in the longitudinal direction, there are the breakers disclosed in JP, A, 11-129109 stated earlier and others. However, when a cutting blade comprises a superabrasive compact like the case of the present embodiment, the cutting blade is very hard and therefore it is not easy to form such breakers but the dulling treatment by honing can be applied easily. Although the cutting edge 6 of the cutting blade 5 is rounded and the sharpness is dulled, the cutting blade 5 comprises a superabrasive compact, hence is excellent in machinability, and is also excellent in dimensional accuracy. Note that, the nick grooves 7 and the rounding treatment of the cutting blade 5 are exaggerated in the figures.

As stated above, in the present embodiment, since the cutting blade 5 is provided with the nick grooves 7 as the lateral separation means for separating swarf in the lateral direction and the rounding treatment as the longitudinal separation means for separating the swarf in the longitudinal direction, the swarf is: separated in both the lateral and longitudinal directions; fractionized to a large extent; excellent in dischargeability; and prevented from being entangled in the tool and damaging the material being machined. Further, as stated above, since the cutting blade comprising a superabrasive compact keeps a good machinability, the cutting blade does not cause swarf to deposit, thus does not damage the material being machined with the deposited swarf, and can obtain good dimensional accuracy. On the contrary, when a cutting blade is made of a carbide steel or the like and then rounded for example, the machinability deteriorates extremely, deposition tends to occur, and the processing accuracy deteriorates extremely.

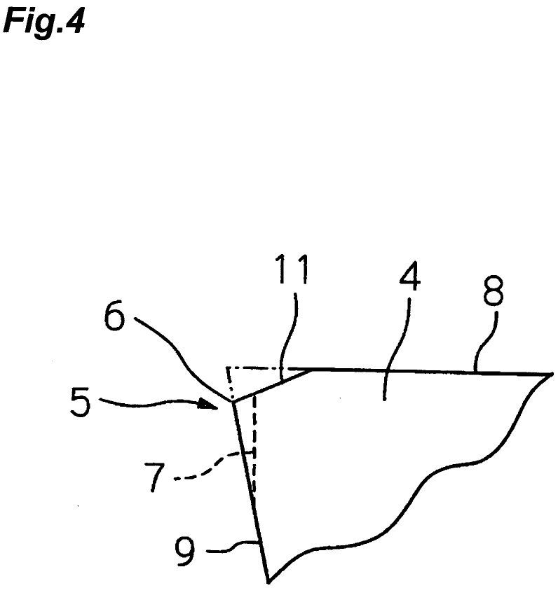

FIG. 4 is a view showing the second embodiment and corresponding to FIG. 2(b) in the first embodiment. In the present embodiment, chamfer treatment is applied in place of the rounding treatment adopted as the dulling treatment in the first embodiment. That is, a edge-side cutting face 11 which is inclined to the cutting face 8 is formed on the cutting face 8 on the side of the cutting edge 6 of the cutting blade 5. By so doing, the angle formed between the edge-side cutting face 11 and the discharging face 9 becomes larger than the angle in the case where the edge-side cutting face 11 is not formed (shown with the two-dot chain line in the figure), and thereby the machinability of the cutting blade 5 deteriorates more than the case where the edge-side cutting face 11 is not formed. Here, the nick grooves 7 are formed at the cutting edge 6 of the cutting blade 5 in the same way as the first embodiment.

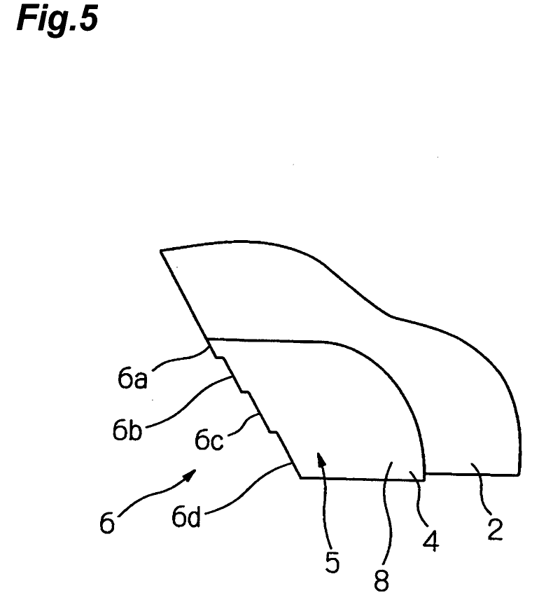

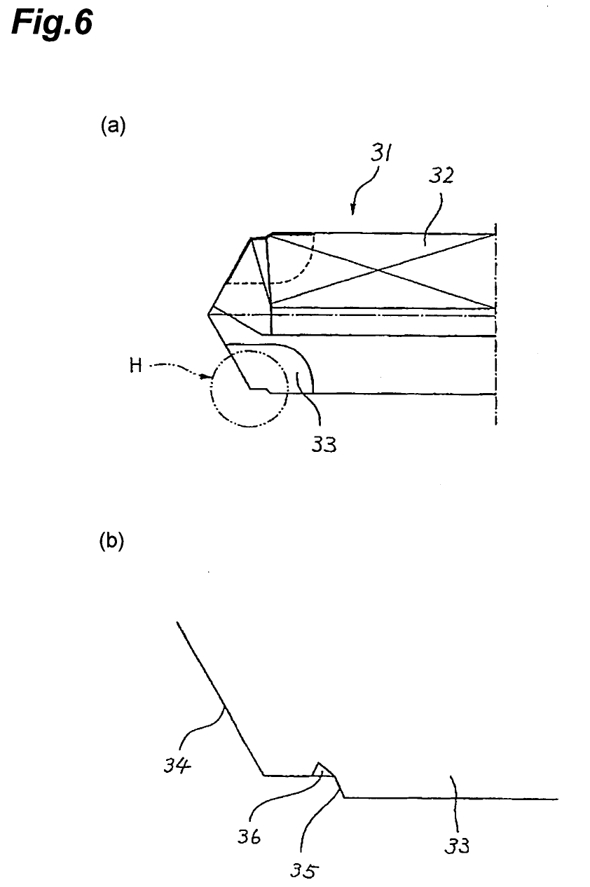

FIG. 5 is a view: showing the third embodiment; showing another example of the lateral separation means; and corresponding to FIG. 2(a) in the first embodiment. In this case, the cutting edge 6 of the cutting blade 5 is formed in a staircase pattern instead of forming nick grooves. That is, the cutting edge 6 is composed of the first, second, third and fourth cutting edges 6a, 6b, 6c, and 6d which are gradually set back to the rear side of the shank 2 in the axial direction from the inside toward the outside of the shank 2 in the radial direction (the step height is exaggerated in the figure). Rounding treatment as the longitudinal separation means is applied to the first, second, third and fourth cutting edges 6a, 6b, 6c, and 6d in the same way as the first embodiment. Here, the cutting edge of the other cutting blade which is mounted on the opposite side at an angle of 180 degrees in the direction of the circumference of the shank 2 is also formed in a staircase pattern likewise but the positions of the steps are differentiated from the positions shown in FIG. 6.

FIG. 6 shows the fourth embodiment; FIG. 6(a) is a partial front view of a reamer 31 and FIG. 6(b) is an enlarged view of the part specified by the symbol H in FIG. 6(a). In the reamer 31 of the present embodiment, a tip 33 comprising a superabrasive compact is firmly fixed to the top end of a shank 32, which is the same as the aforementioned embodiments, but cutting blades are formed at two positions of the tip 33 separately from each other at a distance in the axial direction of the shank. That is, the tip 33 is provided with a first cutting blade 34 formed on the top end side of the shank 32 in the axial direction and a second cutting blade 35 formed on the rear side of the shank 32 in the axial direction so as to be located outside the first cutting blade 34 in the radial direction. Then, although it is not shown in the figure, at least either of the cutting blades 34 and 35 is provided with the lateral separation means and the longitudinal separation means described earlier. The reference numeral 36 represents a back clearance.

### EXAMPLES

As a concrete example, a double-blade tip comprising a diamond compact was firmly fixed to the top end of a helical tooth drill (a helical angle of 20 degrees) 11 mm in diameter by brazing and thereby a cutting blade was formed. The rake angle of the cutting blade was set at 10 degrees. Then nick grooves were formed on the cutting blade, dulling treatment was applied by honing, and thereby a drill was produced. For comparison, a drill which was similar to the above example drill but not subjected to the dulling treatment of nick grooves was produced as comparative example 1 and a drill having only nick grooves was produced as example 2.

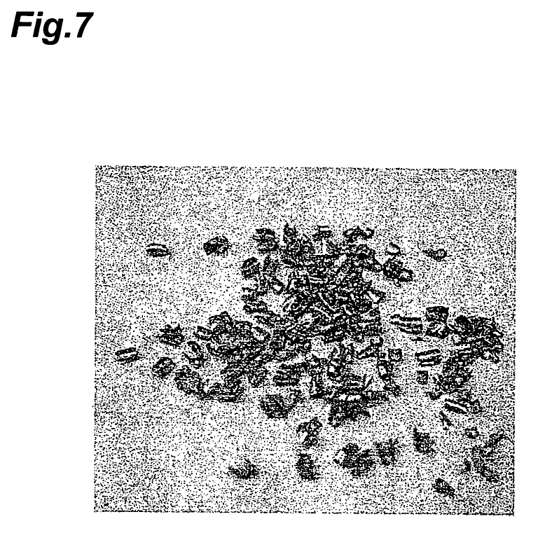

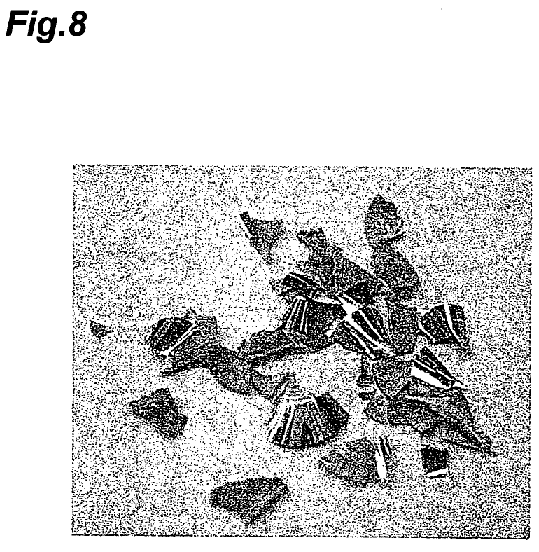

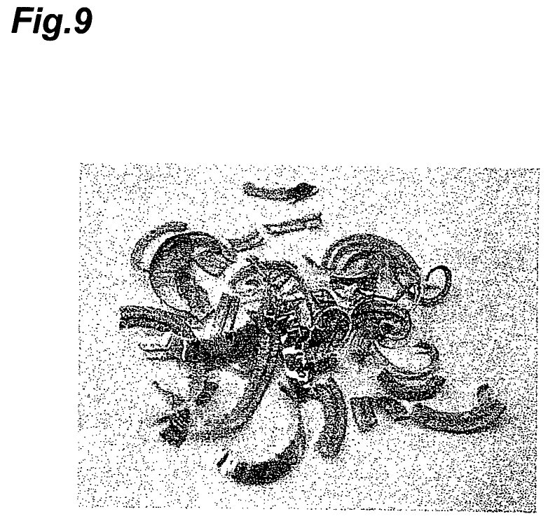

These drills were used for drilling holes in aluminum alloy castings AC2B stipulated in JIS H5202. The drill rotation speed was 2,800 rpm and the drill screw speed was 0.3 mm/rotation. Photographs of the swarf generated by the example, the comparable example 1, and the comparable example 2 are shown in the FIGS. 7, 8, and 9, respectively. As it is obvious from the photographs, the swarf generated in the example was fractionized into very fine pieces in comparison with the comparative examples 1 and 2.

1-4. (canceled)

5. A drilling tool produced by firmly fixing a tip having a superabrasive compact at the top end of a spindle-shaped shank and thus forming cutting blades at the tip, comprising at the cutting edges of the cutting blades: a longitudinal separation means for separating swarf generated at the cutting edges of the cutting blades in the direction of the length of the swarf; and a lateral separation means for separating the swarf in the direction of the width thereof.

6. A drilling tool according to claim 5, wherein the longitudinal separation means is formed by dulling treatment to dull the machinability of the cutting edges, and the lateral separation means includes nick grooves.

7. A drilling tool according to claim 5, wherein the longitudinal separation means is formed by dulling treatment to dull the machinability of the cutting edges, and the lateral separation means includes the cutting blade formed in a staircase pattern.

8. A drilling tool according to claim 6, wherein the dulling treatment is rounding treatment to round the cutting edge.

9. A drilling tool according to claim 7, wherein the dulling treatment is rounding treatment to round the cutting edge.

10. A drilling tool according to claim 6, wherein the dulling treatment is chamfer treatment to form a edge-side cutting face on the cutting face of the cutting blade on the side of the cutting edge of the cutting blade which is inclined to the cutting face so that the angle formed between the edge-side cutting face and the discharging face of the cutting blade becomes larger than the angle in the case where the edge-side cutting face 11 is not formed.

11. A drilling tool according to claim 5, wherein the length of the cutting edges of the cutting blades is three millimeters or longer in the radial direction of the shank.

12. A drilling tool according to claim 6, wherein the length of the cutting edges of the cutting blades is three millimeters or longer in the radial direction of the shank.

13. A drilling tool according to claim 5, wherein at least two or more cutting blades are formed separately from each other at a distance in the axial direction of the shank at positions different from each other in the radial direction of the shank; and at least one of the cutting edges is provided with the longitudinal separation means and the lateral separation means.

14. A drilling tool according to claim 6, wherein at least two or more cutting blades are formed separately from each other at a distance in the axial direction of the shank at positions different from each other in the radial direction of the shank; and at least one of the cutting edges is provided with the longitudinal separation means and the lateral separation means.

15. A drilling tool according to claim 7, wherein at least two or more cutting blades are formed separately from each other at a distance in the axial direction of the shank at positions different from each other in the radial direction of the shank; and at least one of the cutting edges is provided with the longitudinal separation means and the lateral separation means.

16. A drilling tool according to claim 8, wherein at least two or more cutting blades are formed separately from each other at a distance in the axial direction of the shank at positions different from each other in the radial direction of the shank; and at least one of the cutting edges is provided with the longitudinal separation means and the lateral separation means.

17. A drilling tool according to claim 9, wherein at least two or more cutting blades are formed separately from each other at a distance in the axial direction of the shank at positions different from each other in the radial direction of the shank; and at least one of the cutting edges is provided with the longitudinal separation means and the lateral separation means.

18. A drilling tool according to claim 10, wherein at least two or more cutting blades are formed separately from each other at a distance in the axial direction of the shank at positions different from each other in the radial direction of the shank; and at least one of the cutting edges is provided with the longitudinal separation means and the lateral separation means.

19. A drilling tool according to claim 11, wherein at least two or more cutting blades are formed separately from each other at a distance in the axial direction of the shank at positions different from each other in the radial direction of the shank; and at least one of the cutting edges is provided with the longitudinal separation means and the lateral separation means.

20. A drilling tool according to claim 12, wherein at least two or more cutting blades are formed separately from each other at a distance in the axial direction of the shank at positions different from each other in the radial direction of the shank; and at least one of the cutting edges is provided with the longitudinal separation means and the lateral separation means.

21. A drilling tool according to claim 8, wherein at least two or more cutting blades are formed separately from each other in the direction of the circumference of the shank; and the positions of the nick groove formed on one cutting blade are differentiated from the positions of the nick groove formed on the other cutting blade in the longitudinal directions of the cutting blades.

22. A drilling tool according to claim 10, wherein at least two or more cutting blades are formed separately from each other in the direction of the circumference of the shank; and the positions of the nick groove formed on one cutting blade are differentiated from the positions of the nick groove formed on the other cutting blade in the longitudinal directions of the cutting blades.

23. A drilling tool according to claim 9, wherein at least two or more cutting blades are formed separately from each other in the direction of the circumference of the shank; and the positions of the step of the staircase pattern of one cutting blade are differentiated from the positions of the step of the staircase pattern of the other cutting blade in the longitudinal directions of the cutting blades.
